(19) United States
(12) Patent Application Publication
(10) Pub. No.: US 2005/0231647 A1
(43) Pub. Date: Oct. 20, 2005

(54) TV set equipped with a charge unit

(76) Inventor: Chin-Wen Chou, Hsin-Tien (TW)

Correspondence Address: BIRCH STEWART KOLASCH & BIRCH, PO BOX 747, FALLS CHURCH, VA, 22040-0747, US

(21) Appl. No.: 10/823,535

(22) Filed: Apr. 14, 2004

(51) Int. Cl. H04N 5/63

(52) U.S. Cl. 348/730; 348/552

(57) ABSTRACT

A TV set equipped with a charge unit includes a charger that enables users to share an external electric power supply through an electrical processing unit located in a TV set that is installed in a fixed location in a house to charge or supply electric power. Users do not have to purchase additional charging docks and can charge or provide electric power to related devices (such as remote controllers).

### FIELD OF THE INVENTION

The present invention relates to a TV set equipped with a charge unit, and particularly to a TV set that has charging or electric power supply functions.

### BACKGROUND OF THE INVENTION

With the advances of electronic technologies, especially the thriving home entertaining centers and the Internet, the applications of TV sets have also expanded. The number of peripheral devices increased, and battery usage is increasingly becoming a big issue. For instance, TV set, VCR or audio amplifier used in the home entertaining center has to be equipped with at least one remote control. In some situations, even microphones and receivers have to use batteries as an electrical power source. With the development of the Internet, digital TV is often equipped with a wired or wireless keyboard, mouse, game joystick, and the like. It becomes a common phenomenon for a house to prepare and stock a wide variety of batteries. In order to reduce battery expenses and prevent environmental pollution caused by discarded batteries, most users would like to use rechargeable batteries. However, using rechargeable batteries often encounters some problems, notably:
1. Users have to prepare a suitable charging dock for each type of battery. The charging dock is usually a small device and often gets lost. Users have to purchase the charging dock repeatedly if such a situation occurs frequently. It is a waste.
2. To remedy the aforesaid problem, some users have the charge dock mounted on the periphery of a TV set. As each charger has its own power cord, the number of external power supply jacks often is not enough and extension lines or multi-jack sockets have to be added to meet the requirements. As a result, wiring is untidy and difficult to manage. It seriously affects the overall appeal.

### SUMMARY OF THE INVENTION

The primary object of the invention is to solve the aforesaid disadvantages. The invention takes into account that once the TV set is installed; it is rarely moved, providing a suitable recharging base corresponding to the required electric power supply of related devices. Including an electrical processing unit adopting an existing electrical conversion technique to enable the recharge unit to directly share the power of external units so that users do not need to purchase additional charging docks and can obtain electric power supply or charging through the TV set. Thereby users can save the trouble of finding the recharging docks and purchasing costs, and free from the concerns of entangled wiring or not adequate sockets. The entire setup of TV set also is tidier.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1, 2 and 3 are schematic views of various embodiments of the charge battery of the invention.

FIGS. 4, 5 and 6 are schematic views of various embodiments of the invention to provide power supply function.

### DETAILED DESCRIPTION OF THE PREFERRED EMBODIMENTS

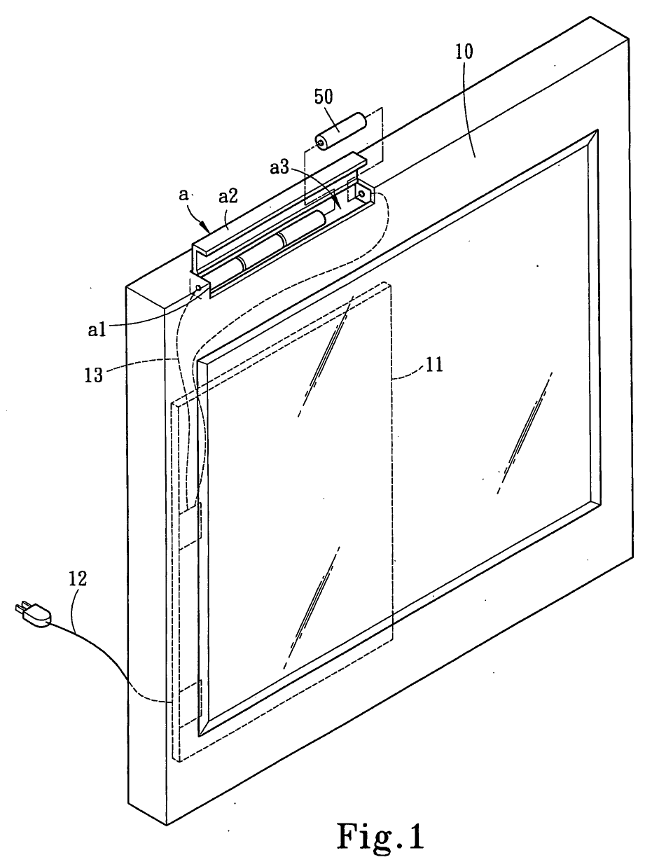

Please refer to FIG. 1, the TV set equipped with a charge unit according to the invention including a TV set 10, an electrical processing unit 11 located inside the TV set 10 and connected to a first power cord 12 for linking to an external electric power supply, a charge unit a located on the TV set 10 connecting to the electrical processing unit 11 through a second power cord 13 to share the external electric power supply.

In one embodiment of the invention, a chargeable battery 50 is provided. The charger includes a charging dock a1 and a cap a2 that form a housing zone a3 to accommodate the chargeable battery 50. When in use, the chargeable battery 50 may serve as the power supply for remote controllers, microphones or the like. When electric power is depleted and recharging is required, there is no need to purchase additional dedicated chargers. The chargeable battery 50 may be mounted in the charging dock a1, and the external power supply can transmit electrical power through the first power cord 12 to the electrical processing unit 11 to perform rectifying and voltage transformation. The charge dock a1 shares the external electric power through the second power cord 13 and charges the charge battery 50 held in the housing zone a3.

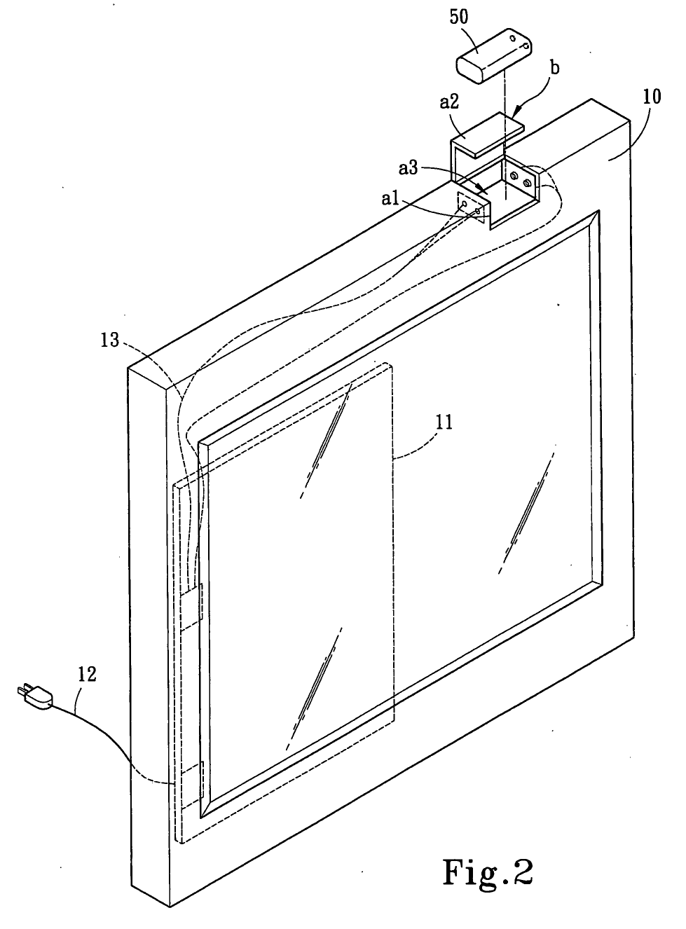

FIG. 2 illustrates another embodiment of the invention aiming at the recharging battery 50 of another specification. The charge battery 50 used in microphones is taken as an example. While using the microphone, the charging battery 50 may be held in the charger b on the TV set 10 to provide the electric power required, or charging may be performed when the electric power of the charge battery 50 is depleted and charging is required. Users do not have to search another dedicated charger, and also do not need to be concerned with interrupting entertainment activities caused by depletion of electric power in the rechargeable battery 50.

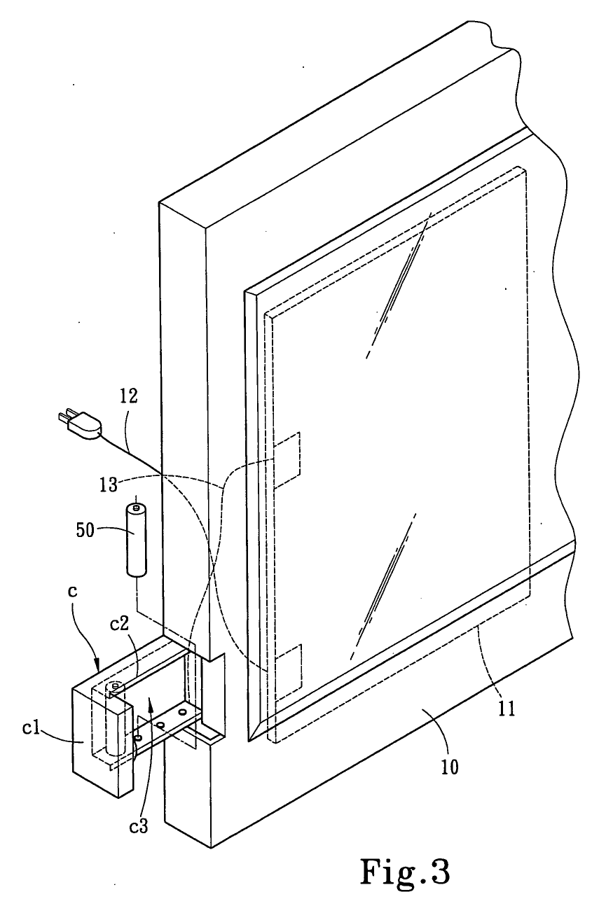

FIG. 3 depicts yet another embodiment that has a charger c in a drawing design. It may be used as the one previously discussed. Details are omitted

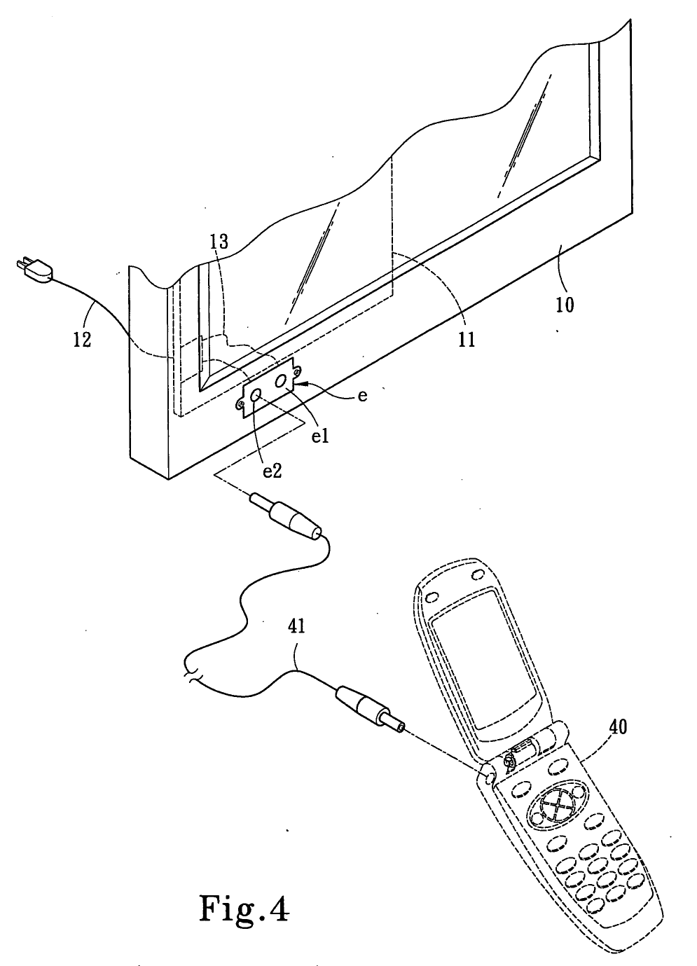

FIG. 4 shows still another embodiment in which a charger e functions as an electric supply dock e1 which includes a power supply jack e2 for a mobile phone 40. Users can link the mobile phone 40 through a power cord 41 to share the electric power and charge through the electrical processing unit 11.

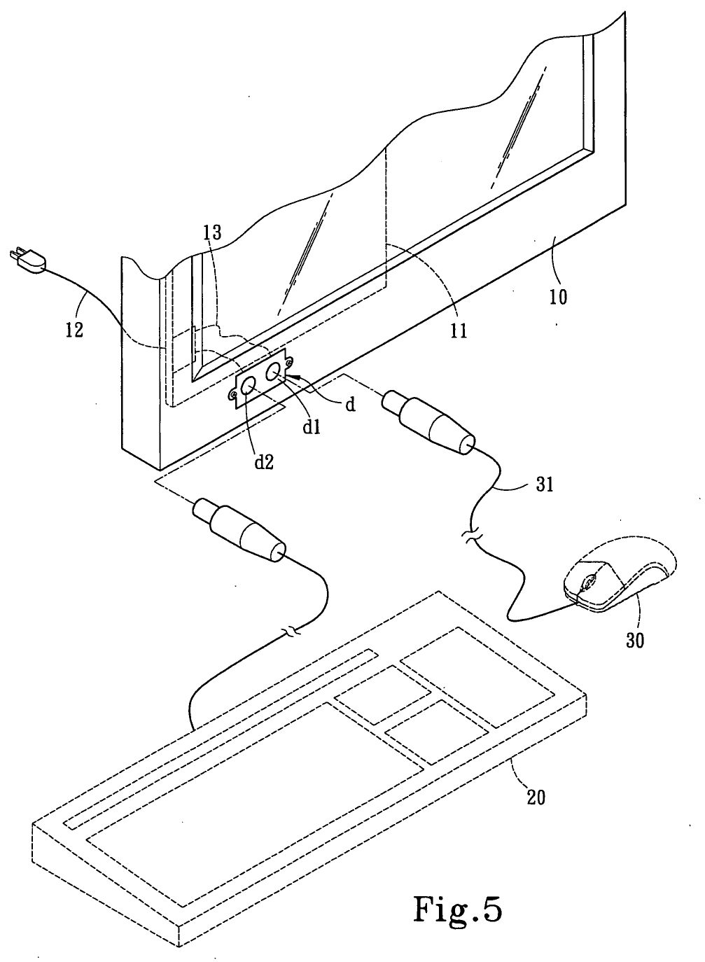

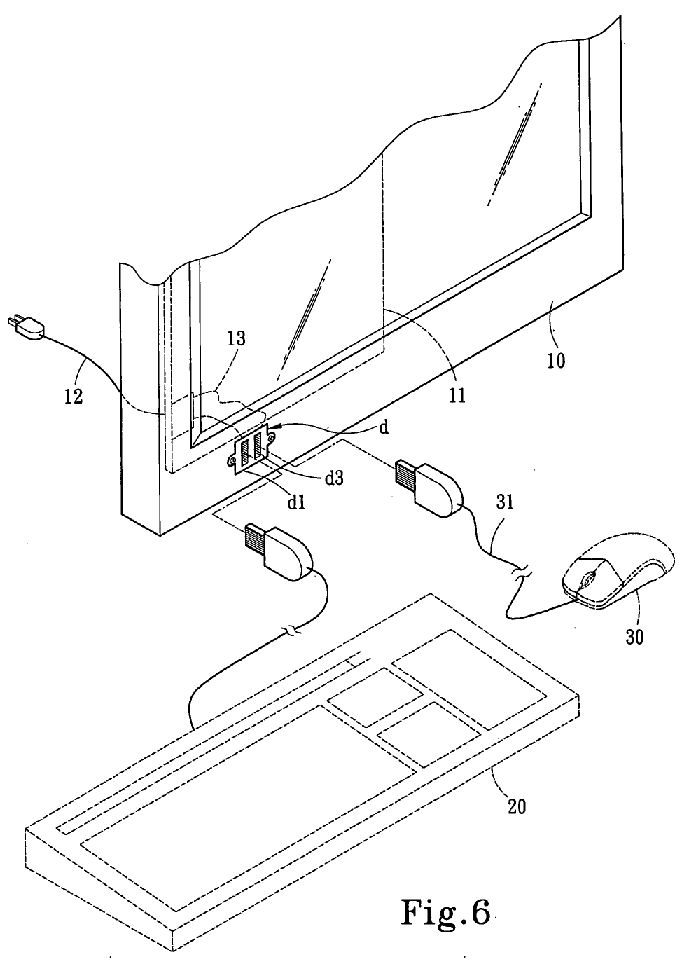

Refer to FIG. 5 for a power supply function provided by the invention. In response to the development of the Internet, by adopting the techniques set forth above, a charge unit d can function as a signal dock d1 with power supply capabilities. It has a bus jack d2 to couple with a connection line 31 of a keyboard 20 or a mouse 30 to share power through the electrical processing unit 11 after having been rectified and transformed. The bus jack d2 shown in FIG. 5 conforms to a PS/2 interface specification. FIG. 6 shows a bus jack d3 conforming to a USB interface specification (for a wireless keyboard 20 or mouse 30, the connection device is a receiver).

1. A TV set equipped with a charge unit, comprising:
a TV set;
an electrical processing unit located in the TV set connecting to an external electric power supply through a first power cord; and
a charger located on the TV set connecting to the electrical processing unit through a second power cord to share the external electric power supply for charging a charge battery.

2. The TV set equipped with a charge unit of claim 1, wherein the charge unit includes a charge dock and a cap that form a housing zone for holding the charge battery.

3. The TV set equipped with a charge unit of claim 1, wherein the charge unit is a signal dock that provides electric power supply and has a bus jack.

4. The TV set equipped with a charge unit of claim 3, wherein the bus jack conforms to a PS/2 interface specification.

5. The TV set equipped with a charge unit of claim 3, wherein the bus jack conforms to a USB interface specification.

6. The TV set equipped with a charge unit of claim 1, wherein the charge unit is an electric power supply dock having a power supply jack for connecting to a mobile phone.
